(19) United States
(12) Patent Application Publication
(10) Pub. No.: US 2018/0065452 A1
(43) Pub. Date: Mar. 8, 2018

(54) USING VISION DEVICES AND TECHNIQUES TO CONTROL SUNLIGHT BLOCKING DEVICES FOR VEHICLES

(71) Applicant: Panasonic Automotive Systems Company of America, Division of Panasonic Corporation of North America, PEACHTREE CITY, GA (US)

(72) Inventor: JIN WOO JUNG, SANDY SPRINGS, GA (US)

(73) Assignee: Panasonic Automotive Systems Company of America, Division of Panasonic Corporation of North America

(21) Appl. No.: 15/686,570

(22) Filed: Aug. 25, 2017

Related U.S. Application Data
(60) Provisional application No. 62/384,565, filed on Sep. 7, 2016.

(51) Int. Cl. B60J 3/02; B60R 11/04

(52) U.S. Cl. CPC B60J 3/0204; B60J 1/2016; B60R 11/04

(57) ABSTRACT

A motor vehicle includes an inside camera capturing images of a passenger compartment of the motor vehicle. An outside camera captures images of an environment outside of the motor vehicle. A movable sunblock device blocks sunlight from impinging upon a portion of the passenger compartment. An electrically powered actuator is coupled to the sunblock device and moves the sunblock device. An electronic processor is communicatively coupled to each of the inside camera, the outside camera, and the actuator. The electronic processor receives images captured by each of the inside camera and the outside camera. The electronic processor transmits control signals to the actuator dependent upon the images captured by each of the inside camera and the outside camera.

### CROSS-REFERENCED TO RELATED APPLICATIONS

This application claims benefit of U.S. Provisional Application No. 62/384,565 filed on Sep. 7, 2016, which the disclosure of which is hereby incorporated by reference in its entirety for all purposes.

### FIELD OF THE INVENTION

The disclosure relates to blocking sunlight in a motor vehicle.

### BACKGROUND OF THE INVENTION

Vehicles are increasingly being equipped with various vision devices such as sensors, cameras, etc. However, visors are the only device provided in most vehicles for blocking direct sunlight, and the passengers of the vehicle must manually move the visors to positions in which the visors block the sunlight. As the vehicle changes heading direction, the angle of the sun relative to the vehicle also changes, and the passengers must regularly manually adjust the positions of the visors in response to the changing angle of the sun.

### SUMMARY

The present invention may use vision devices and apply computer vision and/or machine learning technologies to accurately and intelligently control a sunblock device in a car. A vision device is a device that can produce visual information, such as images (e.g., cameras, sensors, radars). A vision device looking outside of the car (e.g., a surround-view camera) may be referred to as an outward-facing device, and a vision device looking inside of the car (e.g., a driver/passenger monitoring camera) may be referred to as an inward-facing device. Also, computer vision algorithms and machine learning algorithms that can process the output data of the vision devices may be referred to as vision algorithms. The inventive vehicle may have at least one vision device and at least one sunblock device. The sunblock device may include mechanical components, electrical components, and software which enable the sunblock device to be automatically controlled and positioned by other parts/components in the vehicle.

Status information regarding the “sun/sunlight” and “people” in the car may he obtained by using (i) vision devices and (ii) computer vision and/or machine learning algorithms, which may be algorithms applied to the output of the vision device. The sunblock device may be controlled using the status information.

The status of the sun/sunlight can be any information that can be (i) obtained through vision devices (which may be obtained by outward-facing devices like surround-view cameras) and vision algorithms, and (ii) used to control sunblock device(s). The status of the sun/sunlight may include the brightness of the sunlight inside and outside the vehicle, and the location of the sun in the sky, perhaps relative to the vehicle.

Likewise, the status of the people in the car can be any information that can be (i) obtained through vision devices (which may be obtained by inward-facing devices like driver/passenger monitoring cameras) and vision algorithms, and (ii) used to control sunblock device(s). The status of the people in the car may include the location of the person's eyes/head, whether the person is wearing sunglasses, whether the sunlight is shining in the person's eye(s), etc. Through the vision algorithms, the people's status may be determined, such as whether the people inside of the car are actually affected by the sunlight or not. For instance, vision algorithms can decide whether the people are annoyed by the light by analyzing the facial expressions (such as frowning), gestures (such as using one hand to block the sun), etc. The algorithm may also provide a confidence level indicating how confident the algorithm is about the accuracy of the status information.

The controlling of the sunblock device(s) may be performed using the combination of status information described above, dependent on the availability of the status information. The controlling of the sunblock device(s) may include activating/deactivating the sunblock device in the vehicle. Activating the sunblock device may include the sunblock device starting to position itself to block the sunlight, such that the sunblock device(s) create proper shade for the people inside of the car. Deactivating the sunblock device may include the sunblock device starting to go back to its default/original position in which the sunblock does not block the sunlight as much as in the activated position.

The invention may provide high accuracy in automatically positioning sunblock device(s) by collecting location information and positioning the sunblock device(s) based on the location information. The position of sunblock device(s) can be continuously corrected and improved with non-location information.

In one embodiment, the invention comprises a motor vehicle including an inside camera capturing images of a passenger compartment of the motor vehicle. An outside camera captures images of an environment outside of the motor vehicle. A movable sunblock device blocks sunlight from impinging upon a portion of the passenger compartment. An electrically powered actuator is coupled to the sunblock device and moves the sunblock device. An electronic processor is communicatively coupled to each of the inside camera, the outside camera, and the actuator. The electronic processor receives images captured by each of the inside camera and the outside camera. The electronic processor transmits control signals to the actuator dependent upon the images captured by each of the inside camera and the outside camera.

In another embodiment, the invention comprises a method of operating a motor vehicle, including capturing images of a passenger compartment of the motor vehicle, and capturing images of an environment outside of the motor vehicle. A movable sunblock device is used to block sunlight from impinging upon a portion of the passenger compartment. An electrically powered actuator is coupled to the sunblock device such that the actuator may move the sunblock device. The actuator is controlled dependent upon the images captured of the passenger compartment and of the outside environment to thereby control a position of the sunblock device.

In yet another embodiment, the invention comprises a motor vehicle including a camera capturing images of a passenger within a passenger compartment of the motor vehicle. A movable sunblock device blocks sunlight from impinging upon the passenger. An electrically powered actuator is coupled to the sunblock device and moves the sunblock device. An electronic processor is communicatively coupled to the camera. The electronic processor receives images captured by the camera, and transmits control signals to the actuator dependent upon the images captured by the camera.

An advantage of the present invention is that it may enable the position of the sunblock device to be automatically adjusted with very high accuracy. Thus, the invention provides the user an option of fully-automated activation/positioning of the sunblock device, thereby providing a better user experience.

### BRIEF DESCRIPTION OF THE DRAWINGS

A better understanding of the present invention will be had upon reference to the following description in conjunction with the accompanying drawings.

FIG. 1 is a block diagram of one embodiment of a vehicular sunlight blocking control arrangement of the present invention.

FIG. 2A is a schematic diagram of a vehicle including a sunblock device positioned to block the sun.

FIG. 2B is another schematic diagram of the vehicle of FIG. 2a including the sunblock device positioned to block the sun.

FIG. 3 is a flow chart of one embodiment of a sunblock device positioning method of the present invention.

FIG. 4 is a flow chart of one embodiment of a method of the present invention for operating a motor vehicle.

### DETAILED DESCRIPTION OF THE PREFERRED EMBODIMENTS

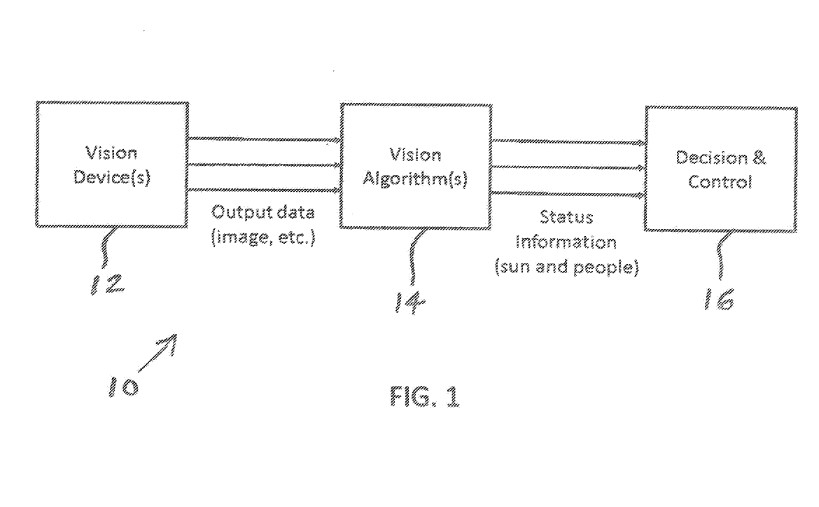

FIG. 1 illustrates one embodiment of a vehicular sunlight blocking control arrangement 10 of the present invention, including vision devices 12, vision algorithms 14, and a decision and control block 16. FIG. 1 is a high-level block diagram of arrangement 10. Vision devices 12 may include cameras, image-capturing devices, and sensors, such as light sensors. Decision and control block 16 performs decision making regarding whether to activate/deactivate sunblock device(s) and how the sunblock device(s) should be positioned. Decision and control block 16 may also include actuators for moving sunblock devices into position.

The combination of status information can be used to activate/deactivate the sunblock device(s). In the case of the activation, if the vision algorithm(s) can confidently determine that the person is having a difficult time looking at the road because of the sun (status of the person), then decision and control block 16 can use that information to automatically activate the sunblock device(s). However, if that information alone is not enough to make a confident decision regarding whether the sunblock device(s) should be activated, then control block 16 can use other information (if available), such as whether the sun is above the horizon, whether the sun is being blocked by clouds, and the location of the sun relative to the eyes of the passengers, to increase the confidence about the issue and use that other information in making the decision about whether to activate the device(s). Similarly, in the case of the deactivation, if algorithm 14 can confidently determine that there is no bright sunlight, then decision and control block 16 can automatically deactivate the sunblock device(s). If, however, algorithm 14 cannot confidently determine that there is no bright sunlight, then decision and control block 16 may also use other available information, such as the location information, to increase the confidence level and use that other available information in making the decision about whether to deactivate the sunblock device(s).

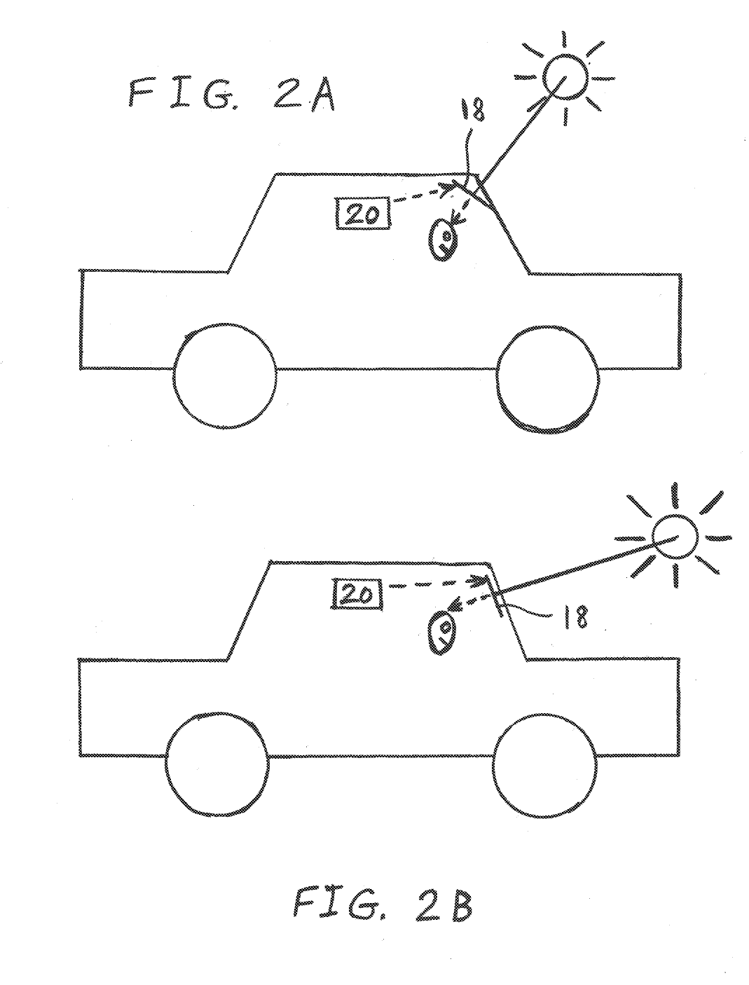

The location information (for the sun and people) may be used to position the sunblock device correctly, as shown in FIGS. 2A-B. These FIGS. 2A-B illustrate an example of positioning the sunblock device based on the location of the sun and the locations of the person's eyes. Sunblock device 18 may be movable between the position shown in FIG. 2A and the position shown in FIG. 2B in order to intercept and block the sunlight from impinging on the passenger's eyes, depending upon the position of the sun in the sky relative to the heading direction of the vehicle. An electrically powered actuator 20 may he coupled to sunblock device 18 such that actuator 20 may move sunblock device 18, such as between the positions shown in FIGS. 2A and 2B. Actuator 20 may be controlled by an electronic processor, such as decision and control block 16.

Non-location information can also be used to position sunblock device(s). For example, the status of the person, such as whether the person is being adversely affected by the sunlight, can be used to determine Whether the current positioning of the sunblock device(s) is adequate. If the current positioning of the sunblock device(s) is not adequate, then the position of the sunblock device(s) may be adjusted until it is determined that the person is no longer being adversely affected by the sunlight.

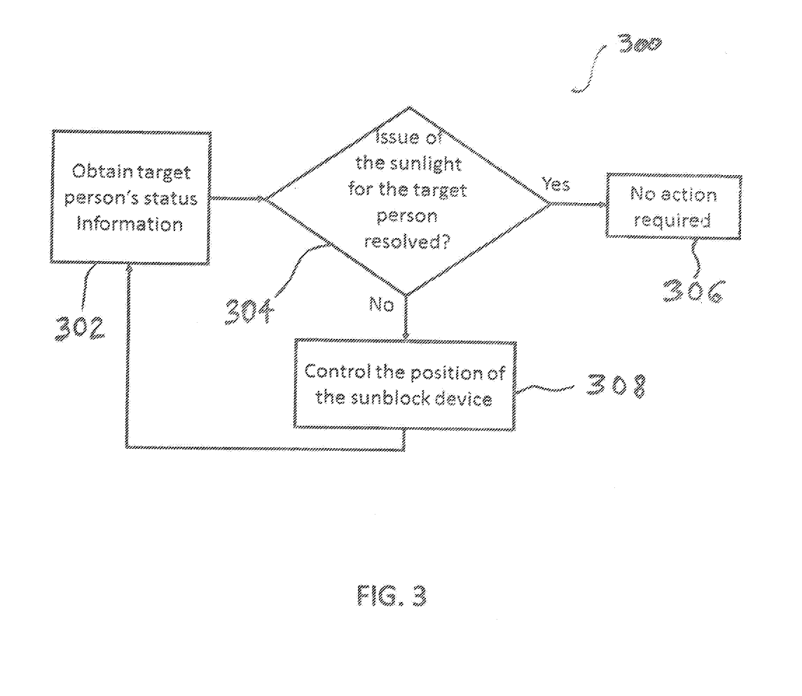

FIG. 3 illustrates a method 300 including providing a feedback loop to control the sunblock device until the person is no longer being adversely affected by the sunlight. In a first step 302, a target person's status information is obtained. For example, in-vehicle cameras and facial recognition software may capture images of the person and determine therefrom whether the sunlight is directly impinging on the person's eyes, whether the person is squinting, grimacing or frowning, or whether the person has moved his eyes to an unusual position in order to position his eyes out of direct sunlight.

Next, in step 304, it is determined whether the current positioning of the sunblock device(s) is adequate. For example, the images captured by the in-vehicle cameras and the output of the facial recognition software may be quantified and compared to one or more thresholds in order to determine whether the sunlit is causing an unacceptable level of difficulty for the target person. If not, then no action is required (step 306). However, if the sunlight is causing an unacceptable level of difficulty for the target person, then operation proceeds to step 308 wherein the position of the sunblock device is adjusted. For example, sunblock device 18 may be moved from the position shown in FIG. 2A to the position shown in FIG. 2B, or vice versa. The sunblock device may be in the form of a visor which may be swung up or down or from side to side. The sunblock device may also be in the form of a window shade which may be pulled down and unrolled to block the sunlight, or rolled back up to expose more window area. After step 308, operation returns to step 302.

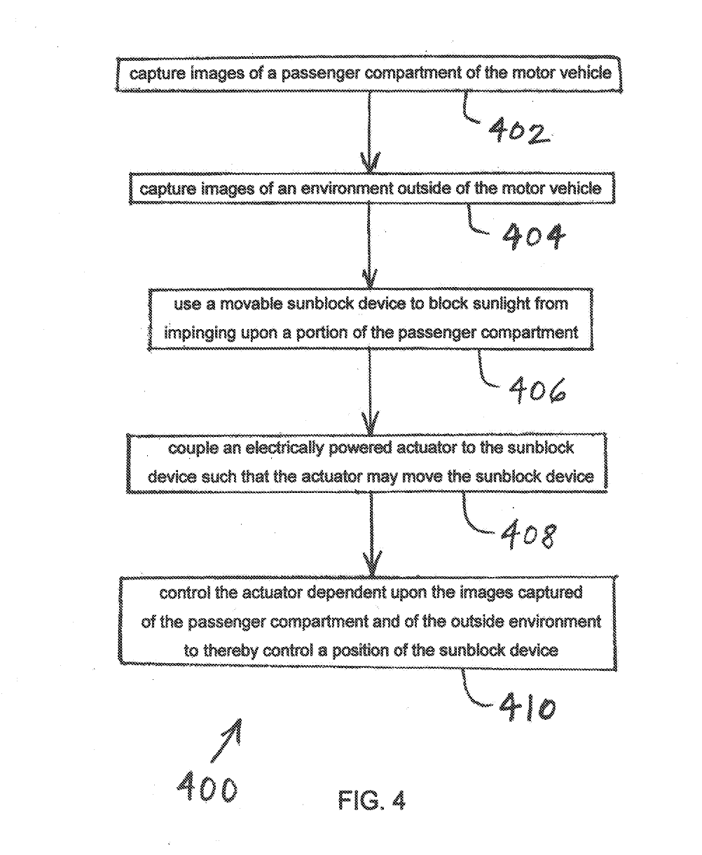

FIG. 4 illustrates one embodiment of a method 400 of the present invention for operating a motor vehicle. In a first step 402, images of a passenger compartment of the motor vehicle are captured. For example, vision devices 12 may capture images of the passenger compartment of a motor vehicle, and of occupants of the vehicle.

Next, in step 404, images of an environment outside of the motor vehicle are captured. For example, vision devices 12 may also capture images of the scene, sky, and lighting conditions surrounding the motor vehicle.

In a next step 406, a movable sunblock device is used to block sunlight from impinging upon a portion of the passenger compartment. For example, sunblock device 18 may be moved from the position shown in FIG. 2A to the position shown in FIG. 2B in order to intercept and block the sunlight from impinging on the passenger's eyes within the passenger compartment.

In step 408, an electrically powered actuator is coupled to the sunblock device such that the actuator may move the sunblock device. For example, actuator 20 may be coupled to sunblock device 18 such that actuator 20 may move sunblock device 18.

In a final step 410, the actuator is controlled dependent upon the images captured of the passenger compartment, and of the outside environment, to thereby control a position of the sunblock device. For example, actuator 20 may be controlled based on images captured of the passenger compartment and of the ambient environment to thereby control a position of sunblock device 18.

The activation and/or deactivation of the sunblock device can be fully automatic or manual. When in the fully-automated mode, the activation and/or deactivation may be decided upon automatically based on the combination of status information described above the manual activation/deactivation mode, the user makes the activation/deactivation decision based upon the sunlight causing him difficulty or not, respectively. There are many ways of implementing the manual activation/deactivation, including buttons and voice commands, for example. Once activated, the positioning of the sunblock device(s) may be automatic, which again may he based on the status information described above. Of course, the user can also manually position the sunblock device, if required. If the sunblock device cannot be positioned automatically due to a lack of information or some other failures, the user may be notified and/or the arrangement may be deactivated.

In one embodiment, through machine learning, decision and control block 16 continuously evolves and learns to quickly find the optimal position of the sunblock device given various situations and inputs.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A motor vehicle, comprising;
an inside camera configured to capture images of a passenger compartment of the motor vehicle;
an outside camera configured to capture images of an environment outside of the motor vehicle;
a movable sunblock device configured to block sunlight from impinging upon a portion of the passenger compartment;
an electrically powered actuator coupled to the sunblock device and configured to move the sunblock device; and
an electronic processor communicatively coupled to each of the inside camera, the outside camera, and the actuator, the electronic processor being configured to;
receive images captured by each of the inside camera and the outside camera; and
transmit control signals to the actuator dependent upon the images captured by each of the inside camera and the outside camera.

2. The motor vehicle of claim 1 wherein the inside camera is configured to capture images of a human passenger within the passenger compartment of the motor vehicle.

3. The motor vehicle of claim 2 wherein the electronic processor is configured to determine whether sunlight is impinging upon an eye of the human passenger, the determining being based on the captured images of the human passenger.

4. The motor vehicle of claim 2 wherein the electronic processor is configured to determine a facial expression of the human passenger, the determining being based on the captured images of the human passenger.

5. The motor vehicle of claim 1 wherein the electronic processor is configured to determine a position of the sun relative to the motor vehicle, the determining being based on the captured images of the outside environment.

6. The motor vehicle of claim 1 wherein the sunblock device comprises a visor.

7. The motor vehicle of claim 1 wherein the electronic processor is configured to determine whether direct sunlight is impinging upon the motor vehicle, the determining being based on the captured images of the outside environment.

8. A method of operating a motor vehicle, the method comprising:
capturing images of a passenger compartment of the motor vehicle;
capturing images of an environment outside of the motor vehicle;
using a movable sunblock device to block sunlight from impinging upon a portion of the passenger compartment;
coupling an electrically powered actuator to the sunblock device such that the actuator may move the sunblock device; and
controlling the actuator dependent upon the images captured of the passenger compartment and of the outside environment to thereby control a position of the sunblock device.

9. The method of claim 8 wherein the capturing of images of the passenger compartment includes capturing images of a human passenger within the passenger compartment of the motor vehicle.

10. The method of claim 9 further comprising determining whether sunlight is impinging upon an eye of the human passenger, the determining being dependent upon the captured images of the passenger compartment of the motor vehicle, the controlling being dependent upon the determining step.

11. The method of claim 9 further comprising determining a facial expression of the human passenger, the determining being based on the captured images of the human passenger, the controlling being dependent upon the determining step.

12. The method of claim 8 further comprising determining a position of the sun relative to the motor vehicle, the determining being based on the captured images of the outside environment, the controlling being dependent upon the determining step.

13. The method of claim 8 wherein the sunblock device comprises a visor.

14. The method of claim 8 further comprising determining whether direct sunlight is impinging upon the motor vehicle, the determining being based on the captured images of the outside environment, the controlling being dependent upon the determining step.

15. A motor vehicle, comprising:
a camera configured to capture images of a human passenger within a passenger compartment of the motor vehicle;
a movable sunblock device configured to block sunlight from impinging upon the passenger;
an electrically powered actuator coupled to the sunblock device and configured to move the sunblock device; and
an electronic processor communicatively coupled to the camera, the electronic processor being configured to:
receive images captured by the camera; and
transmit control signals to the actuator dependent upon the images captured by the camera.

16. The motor vehicle of claim 15 wherein the electronic processor is configured to determine whether sunlight is impinging upon an eye of the human passenger, the determining being based on the captured images of the human passenger, the control signals being dependent upon whether sunlight is impinging upon an eye of the human passenger.

17. The motor vehicle of claim 15 wherein the electronic processor is configured to determine a facial expression of the human passenger, the determining being based on the captured images of the human passenger, the control signals being dependent upon the facial expression of the human passenger.

18. The motor vehicle of claim 15 wherein the sunblock device comprises a visor.

19. The motor vehicle of claim 15 further comprising a sensor configured to detect direct sunlight, the control signals being dependent upon the detection of direct sunlight by the sensor.

20. The motor vehicle of claim 15 further comprising a sensor configured to detect a position of the sun in the sky, the control signals being dependent upon the detected position of the sun in the sky.
